(19) United States
(12) Patent Application Publication
(10) Pub. No.: US 2005/0104805 A1
(43) Pub. Date: May 19, 2005

(54) Portable electronic apparatus

(76) Inventor: Hiroyuki Masaki, Chiba-shi (JP)

Correspondence Address: ADAMS & WILKS, 50 BROADWAY, 31st FLOOR, NEW YORK, NY, 10004, US

(21) Appl. No.: 10/781,287

(22) Filed: Feb. 18, 2004

(30) Foreign Application Priority Data
Feb. 19, 2003 (JP) 2003-041499

(51) Int. Cl. G09G 3/14

(52) U.S. Cl. 345/46

(57) ABSTRACT

A portable electronic apparatus has a display for displaying display segments. A selecting circuit selects one of the display segments displayed by the display. A display brightness controller controls the display so that the display segment selected by the selecting circuit has a display brightness higher than that of the other display segments displayed by the display.

### BACKGROUND OF THE INVENTION

1. Field of the Invention

The present invention relates to a portable electronic apparatus such as an electronic watch that displays time and the like, and particularly to a portable electronic apparatus preferred when equipped with a digital display device of a self-luminous type.

2. Description of the Prior Art

Conventionally, when time data or other such data is displayed in a portable apparatus equipped with a display device such as a liquid crystal panel, the power consumed by the panel itself is extremely low, so that the display is usually performed with the power turned on constantly. However, according to the invention as disclosed in Patent Document 1, there is a rechargeable electronic watch in which a display device is driven in one optimum mode selected from a plurality of clock operation modes different in power consumption according to power generation volume.

In order to render the display visible under a dark environment such as at nighttime, an electroluminescence (EL) or alight-emitting diode (LED) is used for a backlight of a liquid display device, and the backlight is lit for a given period of time after the input of a manipulation switch (sw).

In order to control power consumption at that time, as disclosed in Patent Document 2, the backlight is divided and arranged to light only a necessary portion thereof. For another purpose, according to the invention as disclosed in Patent Document 3, an LED, which is pulse-driven for lower power consumption when used for normal lighting, is DC-driven upon the reception of a standard time electronic wave signal in consideration of noise.

On the other hand, in the case of using a self-luminous element such as an EL, an organic EL, or an LED for a display device, the power consumption is relatively high, so that the operation with the power turned on constantly is difficult from the viewpoint of a commercial value. For example, if the device is operated with the power turned on constantly using a battery installed in a compact portable apparatus such as a watch, the battery capacity becomes too low in a few hours or in a few days, rendering the device practically unusable.

Further, according to the inventions as described in Patent Documents 4 and 5, lower power consumption is achieved by inputting the time of turning on/off the power in advance, using photodetector means to adjust the brightness according to ambient light, and turning off the display operation except, for example, when the display operation is performed for only several seconds after the input of a display switch.
[Patent Document 1]
   Japanese Patent Application Laid-open No. 2001-153972 (Paragraph No. 0048-0060, Table 1)
[Patent Document 2]
   Japanese Patent Application Laid-open No. 2002-116269 (Paragraph No. 0031-0032, FIG. 6)
[Patent Document 3]
   Japanese Patent Application Laid-open No. 2001-74864 (Paragraph No. 0077-0080, FIG. 19)
[Patent Document 4]
   Japanese Patent Application Laid-open No. 2001-296377 (Paragraph No. 0009-0010, FIG. 1)
[Patent Document 5]
   Japanese Patent Application Laid-open No. 2001-235563 (Paragraph No. 0025-0026, FIG. 2)

However, in the case of structuring an electronic watch by using the inventions disclosed in Patent Documents 1 to 5, the display is continuously turned on in such a state as to allow a watch function that requires constant power supply and otherwise would be useless, for example, a chronograph or a timer, or to allow modification or setting of time or alarming time, data setting for a timer, or the like. In that case, relatively large power is consumed.

Accordingly, the frequent use of the above-mentioned function or operation of data modification or the like results in that the battery is likely to be greatly exhausted. This raises a problem in that a battery life becomes shorter for a product, providing a user with less usability.

In particular, a self-luminous type display device (current drive type) including an organic EL, an LED, or the like is generally characterized in that since power consumption increases in proportion to a brightness, the more power is consumed with the larger brightness, and further, the more power is proportionally consumed as the lit area becomes wider. Therefore, an electronic watch using the self-luminous type display device sometimes has no other choice but to have the display turned on constantly for a function specific to a watch, raising a problem in that the power consumption inevitably becomes extremely high.

Further, the problems apply not only to electronic watches but also to other portable electronic apparatuses.

An object of the present invention is to provide a portable electronic apparatus such as an electronic watch, which performs display that is easy to visually recognize and realizes the display at low power consumption.

### SUMMARY OF THE INVENTION

According to the present invention, there is provided a portable electronic apparatus having display means for displaying a plurality of segments, including: manipulation means for selecting any segment of the plurality of segments; and display brightness control means for controlling the display means such that a display brightness of a segment selected by the manipulation means becomes higher than that of another segment. The display brightness control means controls the display means such that the display brightness of the segment selected by the manipulation means becomes higher than that of another segment.

Here, the apparatus may include time counting means for counting an elapsing time, and may be configured such that the display brightness control means: in response to manipulation of the manipulation means, controls the display means to increase a brightness of the segment to a predetermined value; and when the time counting means has counted a predetermined time, controls the display means to decrease the brightness of the segment to a predetermined value.

Further, the apparatus may be configured such that the display brightness control means: controls the display means to cause the segment selected by the manipulation means to blink for display; and over the elapse of the time counted by the time counting means, controls the display means to decrease a lit time ratio for the segment.

Further, the apparatus may include segment selection control means for selectively supplying a first segment having a predetermined size and a second segment having a predetermined size smaller than the first segment and controls the display means to display the segment having the selected size on the display means, and may be configured such that the segment selection control means: controls the display means to display the segment selected by the manipulation means as the first segment; and controls the display means to display a segment not selected by the manipulation means as the second segment.

Further, the apparatus may be configured such that the display brightness control means: in response to the manipulation of the manipulation means, controls the display means to display an indicator for indicating a lit allowable time; and over the elapse of the time counted by the time counting means, controls the display means to decrease the lit allowable time indicated by the indicator.

Further, the apparatus maybe configured such that: the display means displays the time counted by the time counting means in the segment; and the display brightness control means: in response to the manipulation of the manipulation means, controls the display means to increase the brightness of the segment to a predetermined value; and when the time counting means has counted a predetermined time, controls the display means to decrease the brightness of the segment to a predetermined value.

Further, the display means maybe structured by a self-luminous type display device.

Note that the portable electronic apparatus may be an electronic watch.

### BRIEF DESCRIPTION OF THE SEVERAL VIEWS OF THE DRAWINGS

A preferred form of the present invention is illustrated in the accompanying drawings in which:

FIG. 1 is a block diagram of an electronic watch according to an embodiment of the present invention;

FIG. 2 in an external view of the electronic watch according to the embodiment of the present invention;

FIG. 3 is an explanatory view for describing an operation of an electronic watch according to a first embodiment of the present invention;

FIG. 4 is a flow chart showing processes for the electronic watch according to the first embodiment of the present invention;

FIG. 5 is an explanatory view for describing an operation of an electronic watch according to a second embodiment of the present invention;

FIG. 6 is a flow chart showing processes for the electronic watch according to the second embodiment of the present invention;

FIG. 7 is an explanatory view for describing an operation of an electronic watch according to a third embodiment of the present invention;

FIG. 8 is a flow chart showing processes for the electronic watch according to the third embodiment of the present invention;

FIG. 9 is a timing diagram for describing an operation of an electronic watch according to a fourth embodiment of the present invention;

FIG. 10 is a flow chart showing processes for the electronic watch according to the fourth embodiment of the present invention;

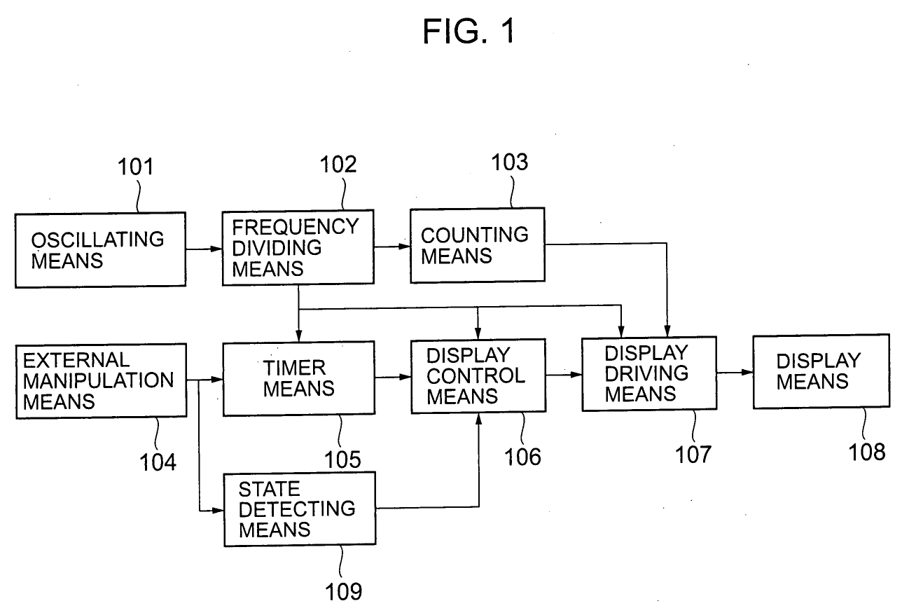

FIG. 1l is an explanatory view for describing an operation of an electronic watch according to a fifth embodiment of the present invention; and

FIG. 12 is a flow chart showing processes for the electronic watch according to the fifth embodiment of the present invention.

### DETAILED DESCRIPTION OF THE PREFERRED EMBODIMENTS

FIG. 1 is a block diagram of a portable electronic apparatus according to an embodiment of the present invention, which is a block diagram common to each embodiment described below, and shows an example of an electronic wrist watch having a chronograph function.

In FIG. 1, the electronic watch includes oscillating means 101 for generating a reference clock signal, frequency dividing means 102 for frequency-dividing the reference clock signal to output a time reference signal to be a reference for a time, counting means 103 for measuring the time by counting the time reference signals to output a time signal corresponding to the measured time, external manipulation means 104 composed of a plurality of manipulation switches that can be externally manipulated, timer means 105 for performing timer operation in response to the manipulation of the external manipulation means 104, display control means 106 for performing various control such as brightness control for display means 108, display driving means 107 for driving display of the display means 108, the display means 108 composed of a display device of a self-luminous type having a plurality of display segments, and state detecting means 109 for detecting a manipulation state of the external manipulation means such as a manipulation state of the manipulation switch.

Note that the display control means 106 and the state detecting means 109 compose display brightness control means and segment selecting means. Also, the timer means 105 composes time counting means.

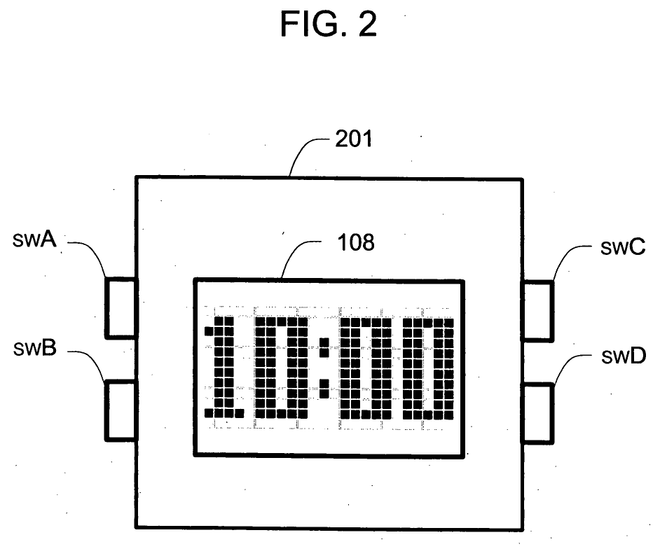

FIG. 2 is a front view showing an external appearance of the electronic watch of FIG. 1, which is an external view common to each embodiment. Note that the same portion as in FIG. 1 is denoted by the same reference numeral.

In FIG. 2, an electronic watch 201 includes the display device 108 of a self-luminous type which can be visually recognized from the outside, and manipulation switches swA, swB, swC, and swD that can be externally manipulated by a user.

The display device 108 is configured to use 4 digits of segments separated with a colon (2 digits of segments indicating hours and 2 digits of segments indicating minutes) for time display.

The manipulation switch swA has a function as a manipulation switch for performing the switching of display modes or the like, and the manipulation switch swB has a function as a manipulation switch for entering a data setting mode for time modification or the like. The manipulation switch swC has a function as a manipulation switch for performing the selection of a segment to be modified in the data setting mode, and performing start/stop in a chrono mode that enables a function as a chronograph. Also, the manipulation switch swD has a one-shot setting function (a function for incrementing or decrementing data value by 1 each time the manipulation switch swD is pressed) or a fast-forward setting function (a function for automatically incrementing or decrementing data value while the manipulation switch swD is pressed and held). Note that the manipulation switches swA, swB, swC, and swD compose the external manipulation means 104 of FIG. 1.

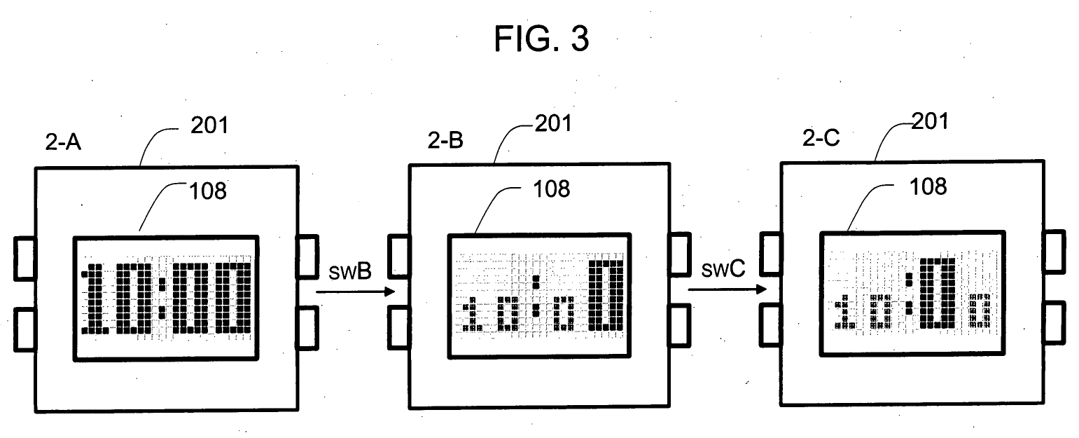

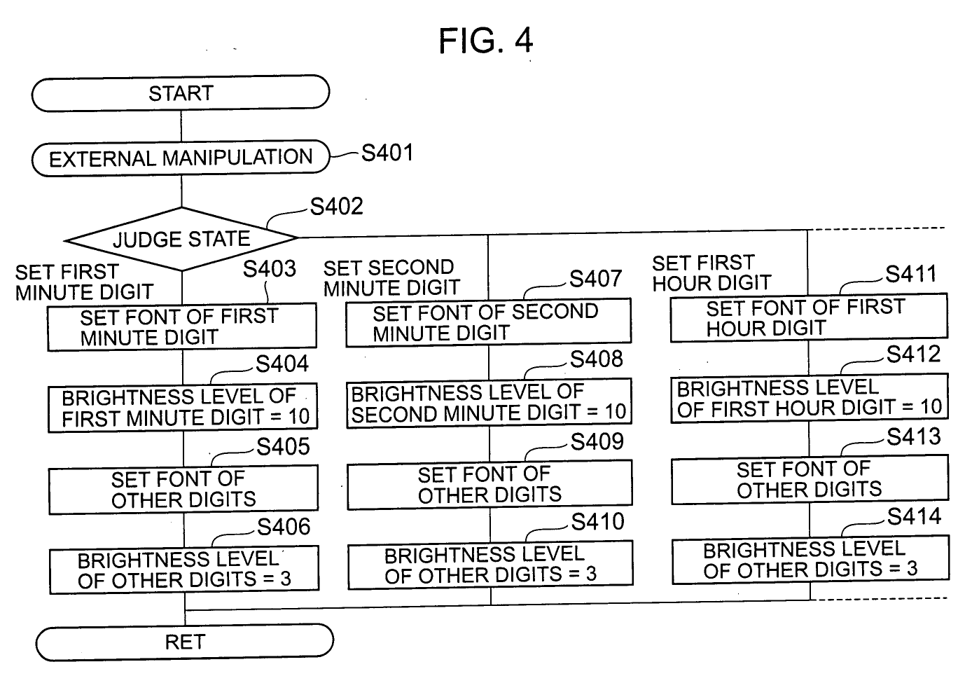

FIG. 3 is an explanatory view for describing an operation of an electronic watch according to a first embodiment of the present invention. Also, FIG. 4 is a flow chart showing processes for the electronic watch according to the first embodiment of the present invention. According to the first embodiment, when a manipulation switch is manipulated, a necessary segment is displayed at a higher brightness than the other segments, and the necessary segment is displayed on a larger scale than the other segments.

Hereinafter, description will be made of the first embodiment referring to FIGS. 1 to 4.

In order to enter a time modification mode that is a kind of data setting mode, the manipulation switch swB is subjected to predetermined manipulation (step S401 of FIG. 4) in a normal time display mode (see 2-A of FIG. 3). The state detecting means 109 then notifies the display control means 106 of the predetermined manipulation of the manipulation switch swB. Based on the notification, the display control means 106 judges whether or not the manipulation switch swB has been subjected to the predetermined manipulation (step S402).

Upon the judgment that the manipulation switch swB has been subjected to predetermined manipulation in the normal time display mode, the display control means 106 controls the display means 108 to change the brightness and the font size between the necessary segment for time modification and the other segments.

More specifically, the display control means 106 sets the font of a first-minute-digit segment to a predetermined large (first) font (step S403), and sets the brightness level of the first-minute-digit segment to a predetermined high (first) brightness level (maximum brightness level of 10 in this embodiment) (step S404). Subsequently, the display control means 106 sets the font of segments except the first-minute-digit segment (a second-minute-digit segment indicating the second digit of the minutes, a first-hour-digit segment indicating the first digit of the hours, and a second-hour-digit segment indicating the second digit of the hours) to a second font smaller than the first font (step S405), and sets the brightness level of the segments except the first-minute-digit segment to a second brightness level (brightness level of 3 in this embodiment) lower than the first brightness level (step S406).

The display control means 106 controls the display means 108 to perform the display according to the above-mentioned settings. Therefore, as shown in FIG. 3, the display means 108 subjects only the first-minute-digit segment to large-font display with the first font and high-brightness display at the first brightness level, while subjecting the other segments to small-font display with the second font and low-brightness display at the second brightness level (see 2-B).

Accordingly, the configuration allows the display such that only the necessary segment is easy to visually recognize, thereby producing an effect that a modification segment is easy to visually recognize in the case of data setting. In addition, only the modification segment consumes large power and the other segments consume only small power, thereby achieving lower power consumption as a whole.

In that state, the manipulation switch swC is manipulated to select the second-minute-digit segment (step S401). The state detecting means 109 then notifies the display control means 106 of the predetermined manipulation of the manipulation switch swC. Based on the notification, the display control means 106 judges whether or not the manipulation switch swC has been subjected to the predetermined manipulation (step S402). Upon the judgment that the manipulation switch swC has been manipulated in step S402, the display control means 106 controls the display of the second-minute-digit segment for easy visual recognition.

More specifically, the display control means 106 sets the font of the second-minute-digit segment to the first font (step S407), and sets the brightness level of the second-minute-digit segment to the first brightness level (step S408). Subsequently, the font of segments except the second-minute-digit segment is set to the second font (step S409), and the brightness level of the segments except the second-minute-digit segment is set to the second brightness level (step S410).

Therefore, as shown in 2-C of FIG. 3, only the second-minute-digit segment is subjected to the large-font display with the first font and the high-brightness display at the first brightness level, while the other segments are subjected to the small-font display with the second font and the low-brightness display at the second brightness level. Accordingly, similarly to the above case, the modification segment becomes easy to visually recognize, and the lower power consumption can be achieved.

In that state, the manipulation switch swC is manipulated to select the first-hour-digit segment (step S401). The state detecting means 109 then notifies the display control means 106 of the predetermined manipulation of the manipulation switch swC. Based on the notification, the display control means 106 judges whether or not the manipulation switch swC has been subjected to the predetermined manipulation (step S402). Upon the judgment that the manipulation switch swC has been manipulated in step S402, the display control means 106 controls the display of the first-hour-digit segment for easy visual recognition.

More specifically, the display control means 106 sets the font of the first-hour-digit segment to the first font (step S411), and sets the brightness level of the first-hour-digit segment to the first brightness level (step S412). Subsequently, the font of segments except the first-hour-digit segment is set to the second font (step S413), and the brightness level of the segments except the first-hour-digit segment is set to the second brightness level (step S414).

Therefore, only the first-hour-digit segment is subjected to the large-font display with the first font and the high-brightness display at the first brightness level, while the other segments are subjected to the small-font display with the second font and the low-brightness display at the second brightness level. Accordingly, similarly to the above case, the modification segment becomes easy to visually recognize, and the lower power consumption can be achieved.

In that state, when the manipulation switch swC is further manipulated similarly to the above case, the display control means 106 selects the second-hour-digit segment as the modification segment. Only the second-hour-digit segment is subjected to the large-font display with the first font and the high-brightness display at the first brightness level, while the other segments are subjected to the small-font display with the second font and the low-brightness display at the second brightness level. Accordingly, similarly to the above case, the modification segment becomes easy to visually recognize, and the lower power consumption can be achieved.

Note that the first embodiment is configured such that both the brightness and the font size are changed between the necessary portion and the other portions. More specifically, in the case where the digit to be modified or set (modification segment) is selected in the data setting mode for time modification, message setting, or the like, a character portion to be modified or set is increased in the brightness, and the other portions are decreased in the brightness and the font size. However, the configuration may be such that only the font size is changed or only the brightness is changed.

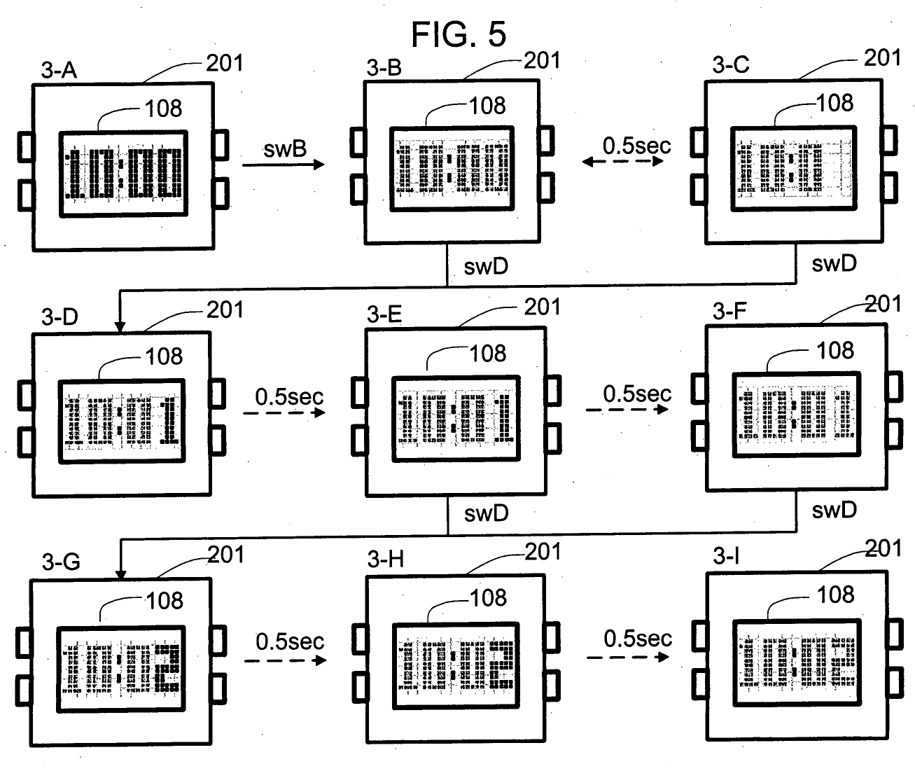

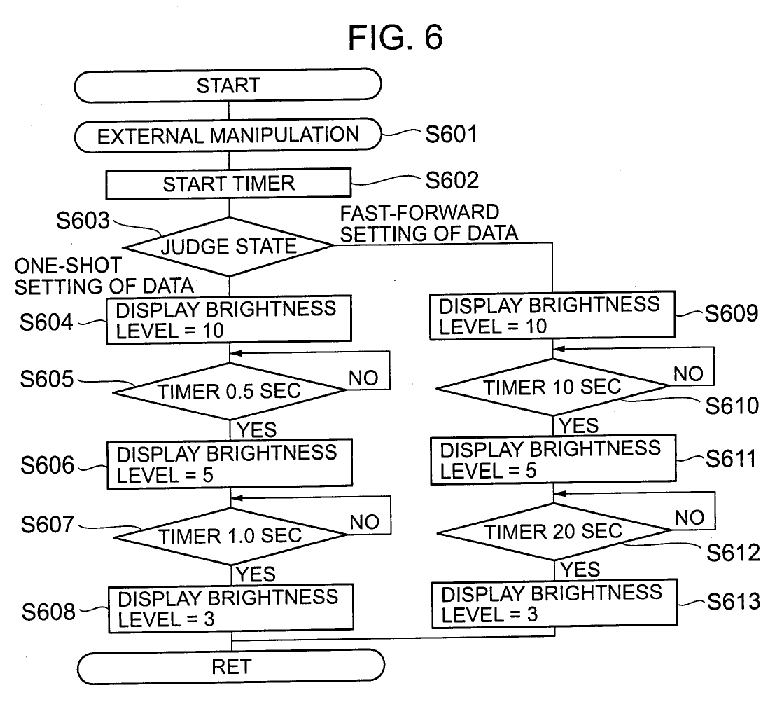

FIG. 5 is an explanatory view for describing an operation of an electronic watch according to a second embodiment of the present invention. Also, FIG. 6 is a flow chart showing processes for the electronic watch according to the second embodiment of the present invention. According to the second embodiment, when a manipulation switch is manipulated, only the necessary segment is displayed at a high brightness, and then the brightness of the segment is gradually decreased over the elapse of time.

Hereinafter, description will be made of the second embodiment referring to FIGS. 1, 2, 5, and 6.

In order to enter the data setting mode for time modification, data rewriting, or the like, the manipulation switch swB is subjected to predetermined manipulation (step S601 of FIG. 6) in a time display mode (see 3-A of FIG. 5). The timer means 105 then starts time counting operation (step S602), and the state detecting means 109 notifies the display control means 106 of the predetermined manipulation of the manipulation switch swB.

The display control means 106 causes a segment for data setting to blink at a predetermined cycle (0.5-second cycle in the second embodiment) in response to the predetermined manipulation of the manipulation switch swB (see 3-B and 3-C of FIG. 5). Note that the sequence of segments for data setting is previously set in storage means of the display control means 106. In the case of performing data setting on a plurality of segments, in response to the predetermined manipulation of the manipulation switch swB, the first segment for data setting is selected, and caused to blink for display as described above. Also, in 3-B and 3-C of FIG. 5, all the segments capable of data setting are displayed at the second brightness level corresponding to a low brightness.

Subsequently, based on the notification from the state detecting means 109, the display control means 106 judges whether the manipulation of the manipulation switch swD has been performed for one-shot setting or fast-forward setting (step S603).

Upon the judgment that the manipulation switch swD has been manipulated for one-shot setting in step S603, the display control means 106 controls the display means 108 such that the display brightness of the segment for data setting (the first-minute-digit segment in the second embodiment) is set to the first brightness level (maximum brightness level of 10 in the second embodiment) higher than the second brightness level (step S604) (see 3-D of FIG. 5). Therefore, on the display means 108, only the segment for data setting is displayed at a high brightness, and the other segments are displayed at a low brightness. Accordingly, the segment selected for data setting (data setting segment) becomes easy to visually recognize. In addition, only the data setting segment consumes large power and the other segments consume only small power, thereby achieving lower power consumption as a whole.

In that state, when the timer means 105 has counted a first predetermined time (0.5 seconds in this embodiment) since the manipulation switch swB was manipulated in step S601 (step S605), the display control means 106 controls the display means 108 such that the display brightness level of the data setting segment is set to the second brightness level (brightness level of 5 in the second embodiment) lower than the first brightness level (step S606) (see 3-E of FIG. 5).

Further, when the timer means 105 has counted a second predetermined time (1.0 second in this embodiment) since the manipulation switch swB was manipulated in step S601 (step S607), the display control means 106 controls the display means 108 such that the display brightness level of the data setting segment is changed to a third brightness level being small (brightness level of 3 in the second embodiment) (step S608) (see 3-F of FIG. 5).

Note that when the manipulation switch swD is manipulated in the state of 3-E or 3-F, the process returns to step S601. Then, the value for the data setting segment of the first minute digit is incremented to “2” (see3-G), and the operation continues similarly to the above as in 3-H and 3-I of FIG. 5.

On the other hand, upon the judgment that the manipulation switch swD has been manipulated for data fast-forward setting in step S603, the display control means 106 sequentially changes the data value of the data setting segment according to the data fast-forward setting manipulation of the manipulation switch swD, and controls the display means 108 such that the display brightness of the data setting segment is set to the first brightness level (step S609). Therefore, on the display means 108, only the data setting segment is displayed at a high brightness, and the other segments are displayed at a low brightness. Accordingly, the data setting segment becomes easy to visually recognize. In addition, only the data setting segment consumes large power and the other segments consume only small power, thereby achieving lower power consumption as a whole.

In a state where fast-forward setting is continuously performed with the manipulation switch swD, when the timer means 105 has counted a third predetermined time (10 seconds in this embodiment) since the manipulation switch swB was manipulated in step S601 (step S610), the display control means 106 sequentially changes the data value of the data setting segment according to the data fast-forward setting manipulation of the manipulation switch swD, and controls the display means 108 such that the brightness level of the data setting segment is changed to the second brightness level (brightness level of 5 in the second embodiment) (step S611).

Further, in a state where fast-forward setting is continuously performed with the manipulation switch swD, when the timer means 105 has counted a fourth predetermined time (20 seconds in this embodiment) since the manipulation switch swB was manipulated in step S601 (step S612), the display control means 106 sequentially changes the data value of the data setting segment according to the data fast-forward setting manipulation of the manipulation switch swD, and changes the display brightness level of the data setting segment to the third brightness level (brightness level of 3 in the second embodiment) (step S613) . Note that upon the completion of data fast-forward setting, the display brightness level of the data setting segment is returned to the first display brightness. The above processes are repeated hereafter.

As described above, the second embodiment includes the timer means 105 for counting the time elapsing since the manipulation switch for data setting was manipulated, and is configured such that when the data setting manipulation is performed with the manipulation switch, only the display brightness of the segment selected for changing data is increased, and as the elapsing time counted by the timer means 105 becomes larger, the display brightness of the data setting segment is gradually decreased.

As a result, according to the second embodiment, the data setting segment becomes easy to visually recognize, and the lower power consumption can be achieved.

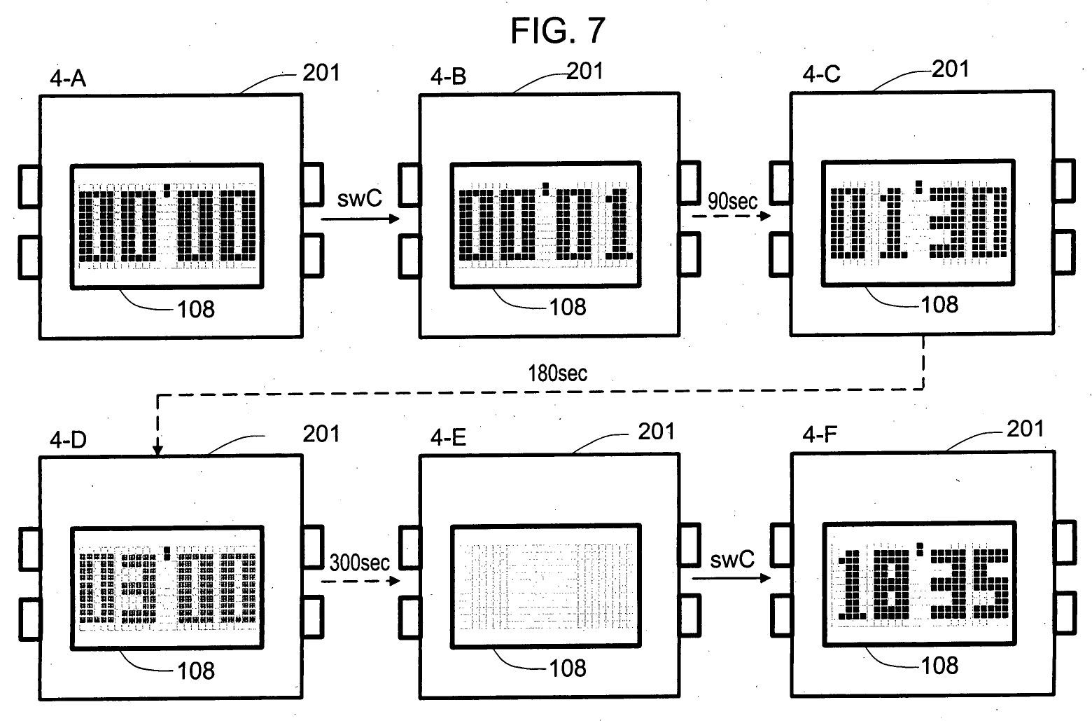

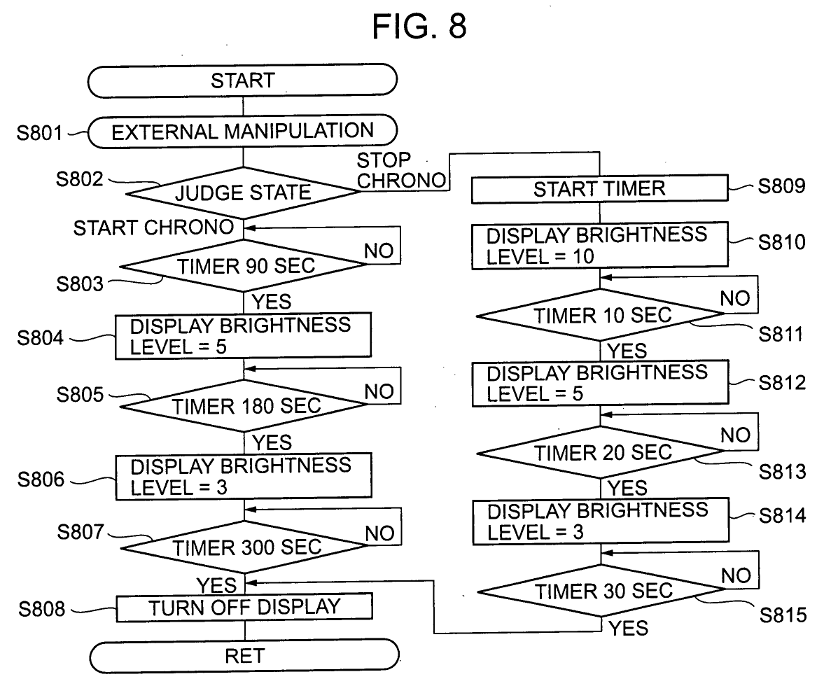

FIG. 7 is an explanatory view for describing an operation of an electronic watch according to a third embodiment of the present invention, and is an explanatory view for describing an operation of a chronograph function. Also, FIG. 8 is a flow chart showing processes for the electronic watch according to the third embodiment of the present invention. According to the third embodiment, when the chronograph function is operated, only the necessary segments for displaying an elapsing time are displayed at a high brightness first, and then the brightness of the segment is gradually decreased over the elapse of time.

Hereinafter, description will be made of the third embodiment referring to FIGS. 1, 2, 7, and 8.

In order to start the time counting operation, the manipulation switch swC is subjected to predetermined manipulation (step S801 of FIG. 8) in a state where the chronograph mode is entered (see 4-A of FIG. 7). The state detecting means 109 then notifies the display control means 106 of the predetermined manipulation of the manipulation switch swC. Based on the notification, the display control means 106 judges whether or not the manipulation has been performed for starting or stopping the chronograph function (step S802).

Upon the judgment that the manipulation has been performed for starting the chronograph function in step S802, the display control means 106 controls the display means 108 such that all the segments for displaying an elapsing time are displayed at the first brightness level being high (a brightness level of 10 in the third embodiment) (see 4-B of FIG. 7), and causes the timer means 105 to start the time counting operation. That is, at the start of the chronograph, the respective segments for displaying the elapsing time are displayed on the display means 108 at the first brightness.

Subsequently, upon the judgment that the timer means 105 has counted 90 seconds (step S803), the display control means 106 controls the display means 108 such that the display brightnesses of all the segments for displaying the elapsing time are changed for display to the second brightness level (brightness level of 5 in the third embodiment) lower than the first brightness level (step S804) (see 4-C of FIG. 7).

Subsequently, upon the judgment that the timer means 105 has counted 180 seconds (step S805), the display control means 106 controls the display means 108 such that the display brightnesses of all the segments for displaying the elapsing time are changed for display at the third brightness level (brightness level of 3 in the third embodiment) lower than the second brightness level (step S806) (see 4-D of FIG. 7).

Subsequently, upon the judgment that the timer means 105 has counted 300 seconds (step S807), the display control means 106 controls the display means 108 to turn off the display of all the segments for displaying the elapsing time (step S808) (see 4-E of FIG. 7). Thus, the elapsing time is no longer displayed on the display means 108, but the timer means 105 still continues the time counting operation.

On the other hand, upon the judgment that the manipulation has been performed for stopping the chronograph function in step S802, the display control means 106 causes the timer means 105 to start the time counting operation (step S809), and controls the display means 108 such that the display brightnesses of all the segments for displaying the elapsing time are changed for display at the first brightness level (step S810; see 4-F of FIG. 7). Thus, the time that elapsed until that moment is displayed on the display means 108 at the first brightness level.

In that state, upon the judgment that the timer means 105 has counted 10 seconds (step S811) , the display control means 106 controls the display means 108 such that the display brightnesses of all the segments for displaying the elapsing time are changed for display at the second brightness level (brightness level of 5 in the third embodiment) (step S812). Thus, the time that elapsed is displayed on the display means 108 at the second brightness level.

After more time has elapsed in that state, when the display control means 106 judges that the timer means 105 has counted 20 seconds (step S813), the display control means 106 controls the display means 108 such that the display brightnesses of all the segments for displaying the elapsing time are changed for display at the third brightness level (brightness level of 3 in the third embodiment) (step S814). Thus, the elapsing time are displayed at the third brightness level.

After more time has elapsed in that state, when the display control means 106 judges that the timer means 105 has counted 30 seconds (step S815), the display control means 106 controls the display means 108 to turn off the display of all the segments for displaying the elapsing time (step S808). Thus, the elapsing time is no longer displayed on the display means 108.

As described above, according to the third embodiment, the brightness of the entire display is high (at the level 10 in this embodiment) at the start of the chronograph, and as the time measured by the chronograph becomes longer, the display brightness is gradually decreased (in this embodiment, the brightness level turns 5 and 3 every 90 seconds). After 300 seconds elapsed, the display is finally turned off. Also, in the case of performing manipulation for stopping the chronograph with the manipulation switch, upon the manipulation of the manipulation switch, the timer means 105 for counting the time elapsing since the manipulation of the manipulation switch is started, and the display brightness is returned to the original level. Even after the chronograph function becomes a stopping state, the brightness is gradually decreased over the elapse of time (in this embodiment, the brightness level turns 5 and 3 every 10 seconds). Accordingly, the time during the time counting can be displayed by performing the necessary display, and the lower power consumption can be achieved.

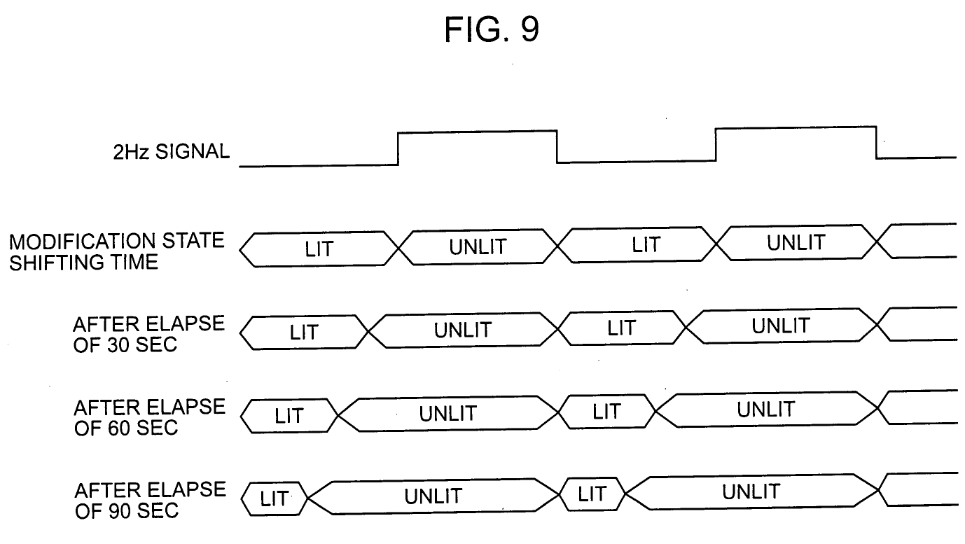

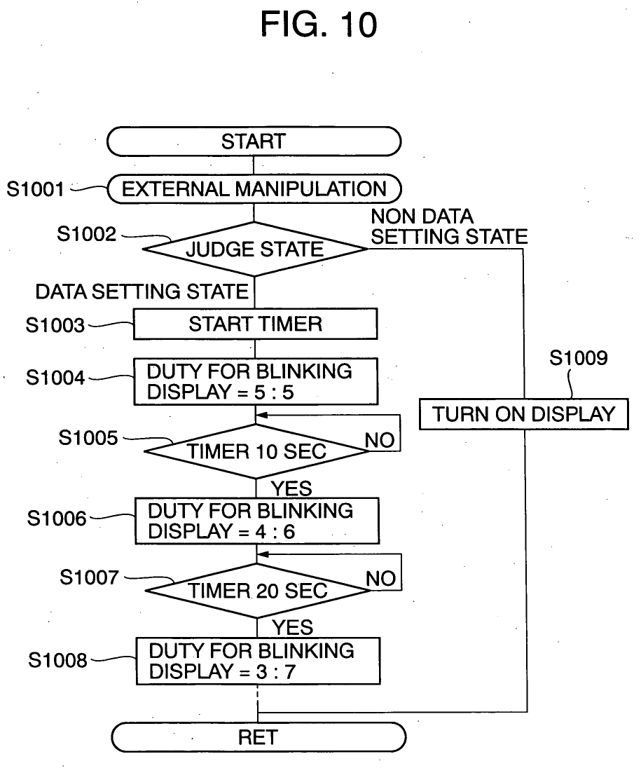

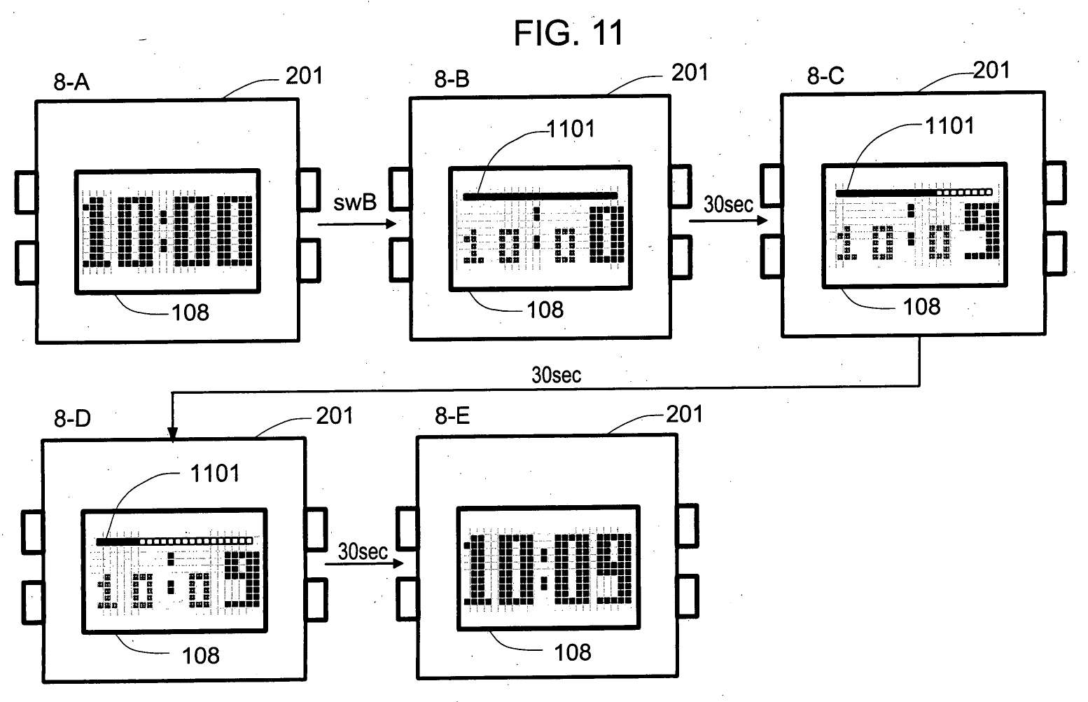

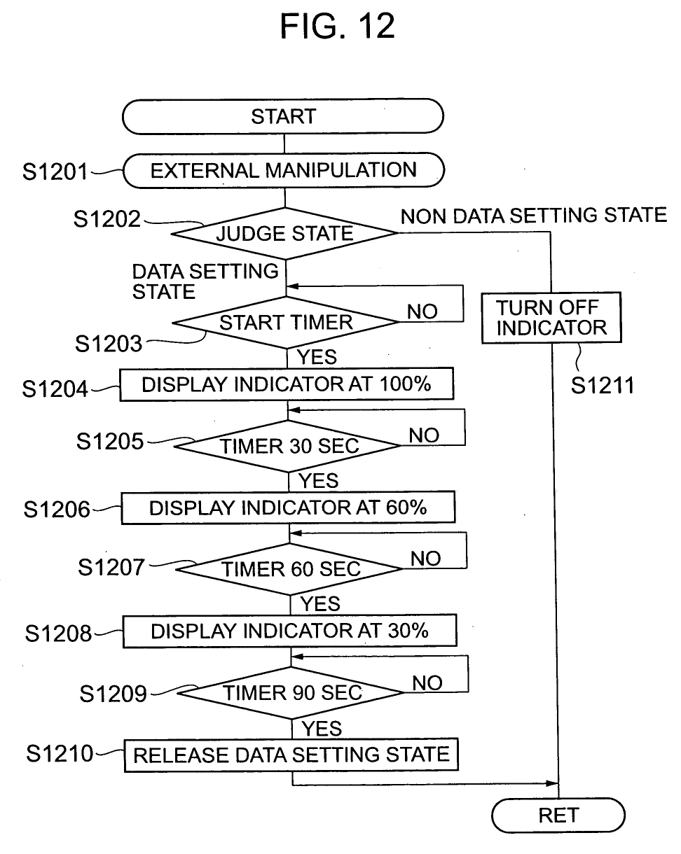

FIG. 9 is a timing diagram for describing an operation of an electronic watch according to a fourth embodiment of the present invention, and FIG. 10 is a flow chart showing processes therefor. The fourth embodiment is configured such that over the elapse of time since the manipulation of the manipulation switch, the blinking time ratio of the segment blinking for display becomes shorter.

Hereinafter, description will be made of the fourth embodiment referring to FIGS. 1, 2, 9, and 10.

In order to perform data setting such as time modification, the manipulation switch swB is subjected to predetermined manipulation (step S1001 of FIG. 10) in the normal time display mode. The state detecting means 109 then notifies the display control means 106 of the predetermined manipulation of the manipulation switch swB. Based on the notification, the display control means 106 judges whether or not the manipulation was performed for shifting to the data setting mode (step S1002).

Upon the judgment that the manipulation switch swB has been manipulated for shifting to the data setting mode in step S1002, the display control means 106 causes the timer means 105 to start the time counting operation (step S1003), and controls the display means 108 such that the segment for data setting is displayed while blinking at a predetermined frequency (2 Hz in the fourth embodiment) and a first duty ratio (duty ratio of 5:5 in this embodiment) exhibiting a high brightness (step S1004; see “modification state shifting time” of FIG. 9). Therefore, at the time of shifting to a time modification state, on the display means 108, the data setting segment is displayed while blinking at a frequency of 2 Hz and a duty ratio of 5:5 exhibiting a high brightness.

In that state, upon the judgment that the timer means 105 has counted 10 seconds (step S1005), the display control means 106 controls the display means 108 such that the segment for data setting is displayed while blinking at a second duty ratio (4:6 in the fourth embodiment) exhibiting a lower luminous brightness than in the case of the first duty ratio (step S1006). Therefore, on the display means 108, the segment for data setting is displayed while blinking at a frequency of 2 Hz and a duty ratio of 4:6.

Subsequently, upon the judgment that the timer means 105 has counted 20 seconds (step S1007), the display control means 106 controls the display means 108 such that the segment for data setting is displayed while blinking at a third duty ratio (3:7 in the fourth embodiment) exhibiting a lower luminous brightness than in the case of the second duty ratio (step S1008). Therefore, on the display means 108, the segment for data setting is displayed while blinking at a frequency of 2 Hz and a duty ratio of 3:7.

Hereafter, similarly to the above, the data setting segment is displayed while blinking at a lit time ratio that is decreased stepwise over the elapse of 30 seconds, 60 seconds, and 90 seconds without manipulating a manipulation switch. Note that if any manipulation switch is manipulated, the duty ratio is returned to 5:5 for display blinking at a high brightness.

On the other hand, upon judgment that the manipulation switch swB is not manipulated for shifting to the data setting mode in step S1002 as in the case where the manipulation switch that has been manipulated is a switch other than the manipulation switch swB, the display control means 106 controls the display means 108 such that all the segments are displayed at the first brightness level (brightness level of 10 in the fourth embodiment) (step S1009), and on the display means 108, all the segments are displayed while lit at a predetermined brightness level (for example, the brightness level of 10).

As described above, the segment to be modified easily becomes visually recognizable, and the lower power consumption can be achieved.

FIG. 11 is an explanatory view for describing an operation of an electronic watch according to a fifth embodiment of the present invention, and FIG. 12 is a flow chart showing processes therefor. According to the fifth embodiment, a lit display allowable time indicator is displayed for showing a remaining display time that has elapsed since the manipulation switch is manipulated. The lit display allowable time indicator shows how the remaining display time decreases over the elapse of time since the manipulation of the manipulation switch.

Hereinafter, description will be made of the fifth embodiment referring to FIGS. 1, 2, 11, and 12.

When the manipulation switch swB is subjected to predetermined manipulation (step S1201 of FIG. 12) in the time display mode in the state where the respective segments are displayed at the maximum brightness (see 8-A of FIG. 11), the state detecting means 109 then notifies the display control means 106 of the predetermined manipulation of the manipulation switch swB. Based on the notification, the display control means 106 judges whether or not the manipulation switch swB has been subjected to the predetermined manipulation (step S1202).

Upon the judgment that the manipulation switch swB has been subjected to the predetermined manipulation in the time display mode, the display control means 106 causes the timer means 105 to start the time counting operation (step S1203). Also, the display control means 106 controls the display means 108 such that the brightness and the font size are changed in the segment necessary for time modification and the other segments, and controls the display means 108 such that an indicator 1101 for indicating a remaining allowable time is displayed at 100% (step S1204). Therefore, on the display means 108, the modification segment is displayed at the first brightness being high with the first font being large, while the segments other than the modification segment is displayed at the second brightness lower than the first brightness with the second font smaller than the first font. In addition, the indicator 1101 for indicating the time remaining for allowing display (remaining display allowable time) is displayed at 100% (see 8-B of FIG. 11).

In the state where the manipulation switch is not manipulated, upon the judgment that the timer means 105 has counted 30 seconds (step S1205), the display control means 106 controls the display means 108 such that the remaining display allowable time to be indicated by the indicator 1101 becomes 60% (step S1206). Therefore, on the display means 108, the indicator 1101 for the remaining display allowable time is displayed at 60% (see 8-C of FIG. 11).

Subsequently, in the state where the manipulation switch is not manipulated, upon the judgment that the timer means 105 has counted 60 seconds (step S1207), the display control means 106 controls the display means 108 such that the remaining display allowable time to be indicated by the indicator 1101 becomes 30% (step S1208). Therefore, on the display means 108, the indicator 1101 for the remaining display allowable time is displayed at 30% (see 8-D of FIG. 11).

Subsequently, in the state where the manipulation switch is not manipulated, upon the judgment that the timer means. 105 has counted 90 seconds (step S1209), the display control means 106 releases the data setting state, and ends the display of the indicator 1101 to return to the time display mode (step S1210; see 8-E of FIG. 11).

On the other hand, upon the judgment that the data setting state is released in step S1202, the display control means 106 controls the display means 108 to end the display of the indicator 1101 if the indicator 1101 has been displayed up until then (step S1211). Therefore, the display of the indicator 1101 is turned off from the display means 108.

As described above, according to the fifth embodiment, in addition to the configuration of the first embodiment, the time remaining for allowing data setting is displayed with the indicator 1101 resembling a bar chart. The indicator 1101 is displayed at 100% upon shifting to the data setting state, and the display percentage is decreased according to time data counted by the timer means 105. In the case of becoming 0% or the case where manipulation except the data setting manipulation is performed, the indicator display state is forced to end. Accordingly, the modification segment becomes easy to visually recognize, and the lower power consumption can be achieved. Moreover, the user can easily know the time remaining for allowing data setting.

Note that the above-mentioned respective embodiments are described using the electronic watch as an example, but can also be applied to other portable electronic apparatus equipped with the display means such as a mobile phone. Further, in the above-mentioned respective embodiments, the brightness can be changed by changing the duty ratio or drive current for the segment subjected to the display drive.

According to the portable electronic apparatus according to the present invention, the segment for data setting becomes easy to visually recognize, and the lower power consumption can be achieved.

Further, the time remaining for allowing data setting is displayed with the indicator. Accordingly, it is easy to know the. time remaining for allowing data setting.

1. A portable electronic apparatus comprising:
display means for displaying a plurality of display segments;
manipulation means for selecting any one of the display segments displayed by the display means; and
display brightness control means for controlling the display means so that the display segment selected by the manipulation means has a display brightness higher than that of the other display segments displayed by the display means.

2. A portable electronic apparatus according to claim 1; further comprising time counting means for counting an elapsed time period; wherein in response to the selection of the display segment by the manipulation means, the display brightness control means controls the display means to increase the brightness of the selected display segment to a first predetermined value; and wherein when the time counting means has counted a predetermined elapsed time period, the display brightness control means controls the display means to decrease the brightness of the selected display segment to a second predetermined value lower than the first predetermined value.

3. A portable electronic apparatus according to claim 2; wherein the display brightness control means controls the display means to cause the display segment selected by the manipulation means to blink while being displayed; and wherein during the elapsed time period counted by the time counting means, the display brightness control means controls the display means to decrease a lit time ratio of the selected display segment.

4. A portable electronic apparatus according to claim 1; further comprising selection control means for selectively supplying one of the display segments as a first display segment having a first predetermined size and another of the display segments as a second display segment having a second predetermined size smaller than the first predetermined size, and for controlling the display means to display the first and second display segments; and wherein the segment selection control means controls the display means to display the display segment selected by the manipulation means as the first display segment, and controls the display means to display as the second display segment one of the display segments other than the display segment selected by the manipulation means.

5. A portable electronic apparatus according to claim 2; wherein the display brightness control means includes means for controlling the display means to display an indicator for indicating a display brightness time of the display segment selected by the manipulation means and for controlling the display means to decrease the display brightness time indicated by the indicator in accordance with a time counted by the time counting means.

6. A portable electronic apparatus according to claim 2; wherein the display means displays the elapsed time period counted by the time counting means.

7. A portable electronic apparatus according to claim 1; wherein the display means comprises a self-luminous-type display device.

8. A portable electronic apparatus comprising:
a display for displaying a plurality of display segments;
a selecting circuit for selecting one of the display segments displayed by the display; and
a display brightness controller for controlling the display so that the display segment selected by the selecting circuit has a display brightness higher than that of the other display segments displayed by the display.

9. A portable electronic apparatus according to claim 8; further comprising a time counter for counting an elapsed time period; wherein in response to the selection of the display segment by the selecting circuit, the display brightness controller controls the display to increase the brightness of the selected display segment to a first predetermined value; and wherein when the time counter has counted a predetermined elapsed time period, the display brightness controller controls the display to decrease the brightness of the selected display segment to a second predetermined value lower than the first predetermined value.

10. A portable electronic apparatus according to claim 9; wherein the display brightness controller controls the display to display an indicator for indicating a display brightness time of the display segment selected by the selection circuit and controls the display to decrease the display brightness time indicated by the indicator in accordance with a time counted by the time counter.

11. A portable electronic apparatus according to claim 9; wherein the display displays the elapsed time period counted by the time counter.

12. A portable electronic apparatus according to claim 9; wherein the display brightness controller controls the display to cause the display segment selected by the selecting circuit to blink while being displayed; and wherein during the elapsed time period counted by the time counter, the display brightness controller controls the display to decrease a lit time ratio of the selected display segment.

13. A portable electronic apparatus according to claim 8; further comprising a selection controller for selectively supplying one of the display segments as a first display segment having a first predetermined size and another of the display segments as a second display segment having a second predetermined size smaller than the first predetermined size, and for controlling the display to display the first and second display segments; and wherein the selection controller controls the display to display the display segment selected by the selection circuit as the first display segment, and controls the display to display as the second display segment one of the display segments other than the display segment selected by the selection circuit.

14. A portable electronic apparatus according to claim 8; wherein the display comprises a self-luminous-type display device.

15. A portable electronic apparatus comprising:
a display for displaying a plurality of display segments;
selecting means for selecting one of the display segments displayed by the display; and
control means for controlling the display so that the display segment selected by the selecting means has a font size larger than that of the other display segments displayed by the display.

16. A portable electronic apparatus according to claim 15; wherein the display comprises a self-luminous-type display device.

17. A portable electronic apparatus according to claim 15; wherein the control means includes means for controlling the display so that the display segment selected by the selecting means has a brightness higher than that of the other display segments displayed by the display.

18. A portable electronic apparatus according to claim 15; wherein the portable electronic apparatus comprises a timepiece; and wherein the display segments comprise time display segments for displaying time.

19. A portable electronic apparatus according to claim 15; further comprising time counting means for counting an elapsed time period; wherein in response to the selection of the display segment by the selecting means, the control means controls the display to increase the font size of the selected display segment to a first predetermined size; and wherein when the time counting means has counted a predetermined elapsed time period, the control means controls the display to decrease the font size of the selected display segment to a second predetermined value lower than the first predetermined value.

20. A portable electronic apparatus according to claim 19; wherein the control means includes means for controlling the display to cause the display segment selected by the selecting circuit to blink while being displayed; and wherein during the elapsed time period counted by the time counter, the control means controls the display to decrease a lit time ratio of the selected display segment.
